(19) United States
(12) Patent Application Publication
(10) Pub. No.: US 2006/0021515 A1
(43) Pub. Date: Feb. 2, 2006

(54) Control center for a beverage brewer, including a visual indicator of the operational status of the brewer

(75) Inventors: Kenton J. Graviss, Louisville, KY (US); Tharon Hall, Fredericksburg, IN (US); Andrew L. Walston, Seattle, WA (US); Robert Lewis Mallory, Sammamish, WA (US)

Correspondence Address: STITES & HARBISON, PLLC, 400 W MARKET ST, SUITE 1800, LOUISVILLE, KY, 40202-3352, US

(73) Assignee: Grindmaster Corporation

(21) Appl. No.: 11/188,434

(22) Filed: Jul. 25, 2005

Related U.S. Application Data
(60) Provisional application No. 60/591,426, filed on Jul. 27, 2004.

(51) Int. Cl. A47J 31/00

(52) U.S. Cl. 99/279

(57) ABSTRACT

A brewer made in accordance with the present invention has a control center, including a selector switch for strength selection; a brew button to initiate brewing and dispensing of the beverage, and an on/off or power button. The selector switch and buttons are preferably mounted on a common tray that is then interposed between first and second housing portions during assembly of the brewer. There is also an illumination device, such a high-intensity, tri-color light-emitting diode (LED), which emits red light, green light, blue light, or a combination thereof to provide visual indication of an operational status of the brewer.

### CROSS-REFERENCE TO RELATED APPLICATIONS

The present application claims priority to U.S. Provisional Patent Application Ser. No. 60/591,426 filed on Jul. 27, 2004, the entire disclosure of which is incorporated herein by reference.

### FIELD OF THE INVENTION

The present invention relates to beverage brewers, and, more particularly, to the control center for the beverage brewer which includes the buttons and switches for operating the brewer.

### BACKGROUND OF THE INVENTION

A brewer for coffee, tea, or similar beverages commonly includes a plumbing system in which potable water is drawn from a water reservoir via a pump or similar means. As water is drawn from the reservoir and pumped into a hot water tank, hot water is forced from the hot water tank to a brew head. The brew head distributes the hot water over and through the coffee grounds, tea, or similar beverage component, and the brewed beverage is dispensed through an outlet and into a cup or similar receptacle positioned below the brew head.

In brewing coffee or similar beverages, each consumer has his or her own taste preferences. In response, as an alternative to traditional multi-cup brewers, there have been efforts to develop brewers that use a single-serve pod enclosing a beverage component, such as coffee grounds or tea. Such a pod is generally manufactured from two substantially circular sections of filtering paper joined along their respective circumferential edges and enclosing a quantity of beverage component. Such pods are commonly designed for and contain a quantity of beverage component suitable for a single serving of the brewed beverage. By using such single-serve pods, an individual consumer can brew a single serving of a beverage, and furthermore, has some flexibility in determining the relative strength of the brewed beverage.

With respect to determining the relative strength of the brewed beverage, it is contemplated that a consumer be able to select a desired strength, and then, a serving of the brewed beverage is promptly brewed and dispensed in response to that selection. Furthermore, regardless of the selected strength, a constant volume of beverage results; in other words, the strength of the brewed beverage is not altered by merely adding or subtracting water.

As described in co-pending and commonly assigned U.S. patent application Ser. No. 10/894,783 (filed Jul. 20, 2004), an application which is incorporated herein by reference, selection of the desired strength can be accomplished through a selector switch on the front surface of the housing of the brewer. A consumer selects the appropriate setting by rotating the selector switch to the desired position, and then presses a brew button to initiate the brewing process. Regardless of which option is chosen, a constant predetermined volume of brewed beverage is dispensed.

In any event, regardless of whether the brewer is designed for multi-cup or single-serve operation, and regardless of whether there are strength-selection capabilities, Applicants have recognized the need to provide the user with a visual indication of the operational status of the brewer, allowing the user to readily ascertain what is happening in the brewing process.

### SUMMARY OF THE INVENTION

The present invention is a control center for a beverage brewer that includes a visual indicator of the operational status of the brewer.

A brewer made in accordance with the present invention includes a control center, i.e., the array of buttons and switches that control operation of the brewer. An exemplary control center of the brewer specifically includes a selector switch for strength selection; a brew button to initiate brewing and dispensing of the beverage; and an on/off or power button. The selector switch and buttons are preferably mounted on a common tray that is then interposed between first and second housing portions during assembly of the brewer. Furthermore, the power button engages a microswitch mounted below the button on a circuit board in the second housing portion, such that depression of the button closes the microswitch. The microswitch is in electrical communication with a control logic which initiates certain actions in response to the closing of the microswitch. Indeed, this control logic operates all components of the brewer. Similarly, the brew button engages a microswitch mounted below the button on the circuit board in the second housing portion, such that depression of the button closes the microswitch. This microswitch is also in electrical communication with the control logic, which initiates the brewing process in response to the closing of the microswitch.

There is also an illumination device mounted on the circuit board in the second housing portion near the microswitches. In one exemplary embodiment, this illumination device is a high-intensity, tri-color light-emitting diode (LED), which can be programmed to emit red light, green light, blue light, or a combination thereof, as dictated by the control logic. This illumination device is designed to provide visual indication of the operational status of the brewer. Specifically, in one exemplary embodiment, the brew button is surrounded by a cylindrical element that serves as a waveguide or light pipe, directing the light emitted from the illumination device along its length, such that the distal rim of the cylindrical element circumscribing the brew button is illuminated. By illuminating the cylindrical element, the operational status of the brewer can be readily communicated to the user.

### DESCRIPTION OF THE DRAWINGS

FIG. 1 is a perspective view of an exemplary brewer made in accordance with the present invention, with the pivotable cover in a closed position;

FIG. 2 is a perspective view of the exemplary brewer of FIG. 1, with the pivotable cover in an open position;

FIG. 3 is a perspective view of the exemplary brewer substantially identical to FIG. 2, but with the pod holder removed from the brewer;

FIG. 4 is an enlarged front view of the control center of the exemplary brewer of FIG. 1;

FIG. 5 is a enlarged perspective view of the control center of the exemplary brewer of FIG. 1;

FIG. 6 is a partial, exploded perspective view of the exemplary brewer of FIG. 1, illustrating the assembly of the components of the control center;

FIG. 7 is a sectional view of the exemplary brewer of FIG. 1 taken along line 7-7 of FIG. 6;

FIG. 8 is a workflow diagram, illustrating the operation of the exemplary brewer of FIG. 1; and

FIG. 9 is a block diagram that further illustrates the inputs received by and outputs controlled by the control logic of the exemplary brewer of FIG. 1.

### DETAILED DESCRIPTION OF THE INVENTION

The present invention is a control center for a beverage brewer that includes a visual indicator of the operational status of the brewer.

As mentioned above, a brewer for coffee, tea, or similar beverages commonly includes a plumbing system in which potable water is drawn from a water reservoir via a pump or similar means. As water is drawn from the reservoir and pumped into a hot water tank, hot water is forced from the hot water tank to a brew head. The brew head distributes the hot water over and through the coffee grounds, tea, or similar beverage component, and the brewed beverage is dispensed through an outlet and into a cup or similar receptacle positioned below the brew head. The brewer of the present invention operates in this manner, specifically providing and distributing hot water over a quantity of coffee grounds, tea, or similar beverage component.

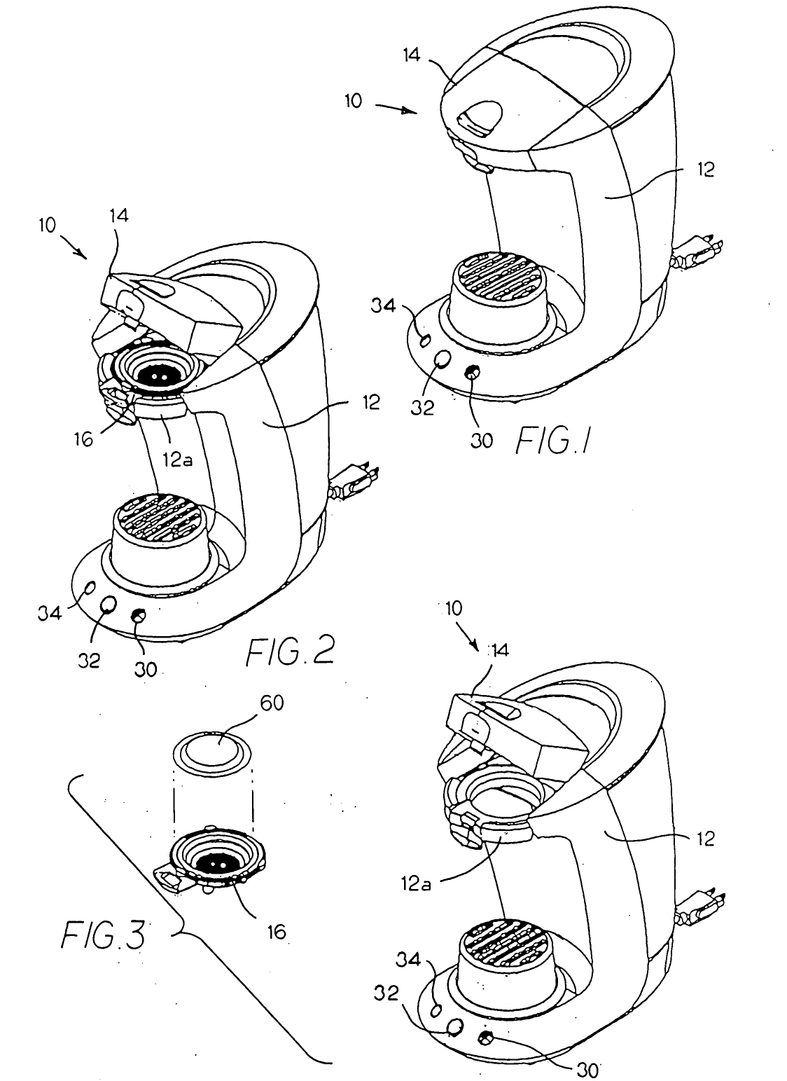

Referring now to FIGS. 1-3, an exemplary brewer 10 made in accordance with the present invention has a housing 12 that includes a pivotable cover 14. Opening and pivoting the cover 14, along with the brew head (which is secured to and pivots with the cover 14), allows access to a portion of the housing, a so-called drawer 12a, that retains the pod 60 in a pod holder 16 below the brew head. As best illustrated in FIG. 3, the drawer 12a defines a substantially circular opening designed to receive the pod holder 16. Accordingly, when the cover 14 is open, the pod holder 16 can be removed from the brewer 10 to replace the pod. Once the pod 60 has been placed in the pod holder 16 and the pod holder 16 returned to the brewer 10, the cover 14 and brew head can be pivoted into a closed position so that the brewing process can commence.

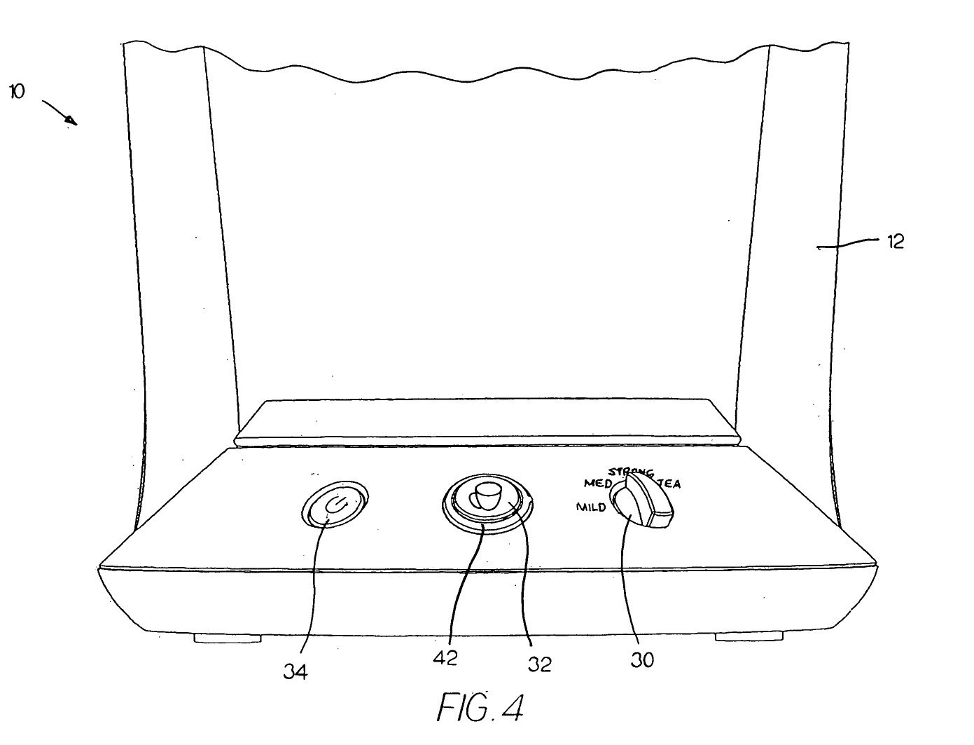

Furthermore, in the exemplary embodiment described herein, the brewer 10 is provided with strength-selection capabilities. In this regard, and similar to the embodiments described and claimed in co-pending and commonly assigned U.S. patent application Ser. No. 10/894,783 (filed Jul. 20, 2004), a selector switch 30 is provided on the front surface of the housing 12 of the brewer 10. As best illustrated in FIG. 4, this particular selector switch 30 has three strength settings for a coffee beverage: (1) a mild setting; (2) a medium setting; and (3) a strong setting, and further includes a fourth setting for tea. A consumer selects the appropriate setting by rotating the selector switch 30 to the desired position, and then presses a brew button 32, which is also located on the front surface of the housing 12 to initiate the brewing process.

If the selector switch 30 is rotated to indicate that a mild coffee is desired, upon pressing the brew button 32, a precise, predetermined volume of water is delivered to the hot water tank of the brewer 10, which, in turn, causes a precise, predetermined volume of hot water to be delivered to the brew head. This predetermined volume of hot water is distributed to and passes over and through the coffee pod, and the brewed coffee is dispensed through an outlet and into a cup or similar receptacle.

If the selector switch 30 is rotated to indicate that a medium coffee is desired, upon pressing the brew button 32, a second predetermined volume of hot water is delivered to moisten the coffee pod. Pumping then ceases for a predetermined time period (for example, 3-5 seconds) to allow for pre-infusion of the coffee grounds to improve extraction and make a stronger brewed coffee. Pumping then resumes until the precise, predetermined volume of water has been delivered to the hot water tank, which, in turn, causes a precise, predetermined volume of hot water to be delivered to the brew head. Again, this predetermined volume of hot water is distributed to and passes over and through the coffee pod, and the brewed coffee is dispensed through an outlet and into a cup or similar receptacle.

If the selector switch 30 is rotated to indicate that a strong coffee is desired, upon pressing the brew button 32, a third predetermined volume of hot water is delivered to the coffee pod, and then pumping ceases for a predetermined time period (for example, 3-5 seconds), with this on-off or “pulsing” cycle continuing until the precise, predetermined volume of water has been delivered to the hot water tank, which, in turn, causes a precise, predetermined volume of hot water to be delivered to the brew head. By providing the periodic “off periods,” a stronger brewed coffee results.

Finally, if the selector switch 30 is provided with an option to brew tea and is rotated to this option, similar to the strong coffee option, a pulsing cycle is used to pump water until the precise, predetermined volume of water has been delivered to the hot water tank, and thus, the brew head. This pulsing cycles is similar to steeping a tea to ensure proper extraction.

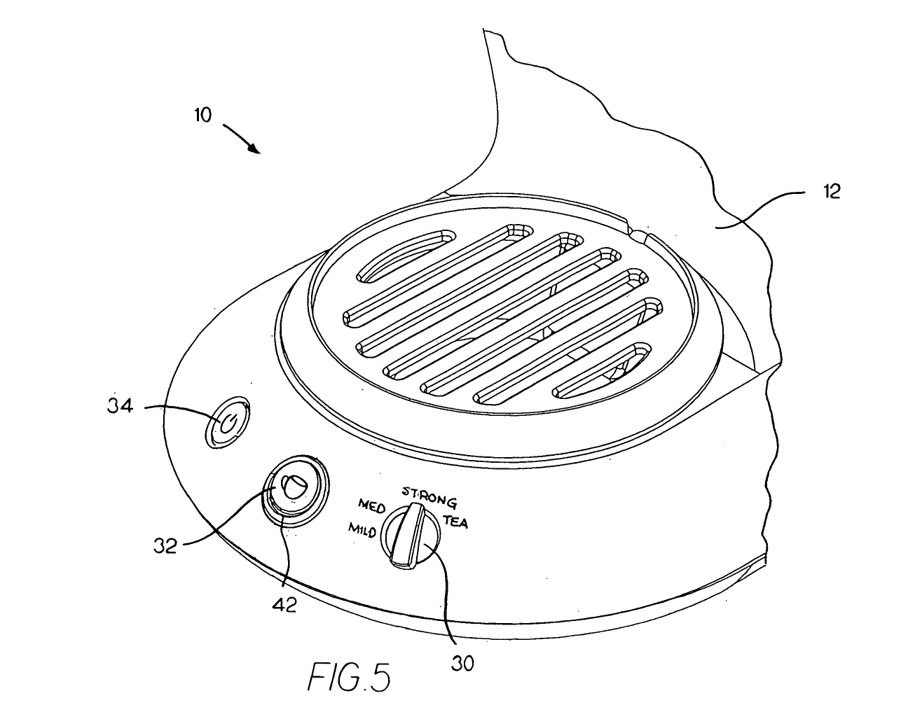

In any event, and as mentioned above, the focus of the present invention is on the control center, i.e., the array of buttons and switches that control operation of the brewer 10. FIGS. 4 and 5 are enlarged views of the control center of the brewer 10, specifically illustrating the selector switch 30 and brew button 32 described above, along with another button—an on/off or power button 34. The switch 30 and buttons 32, 34 are accessible through the front surface of the housing 12 of the brewer 10, along the base portion of the brewer 10.

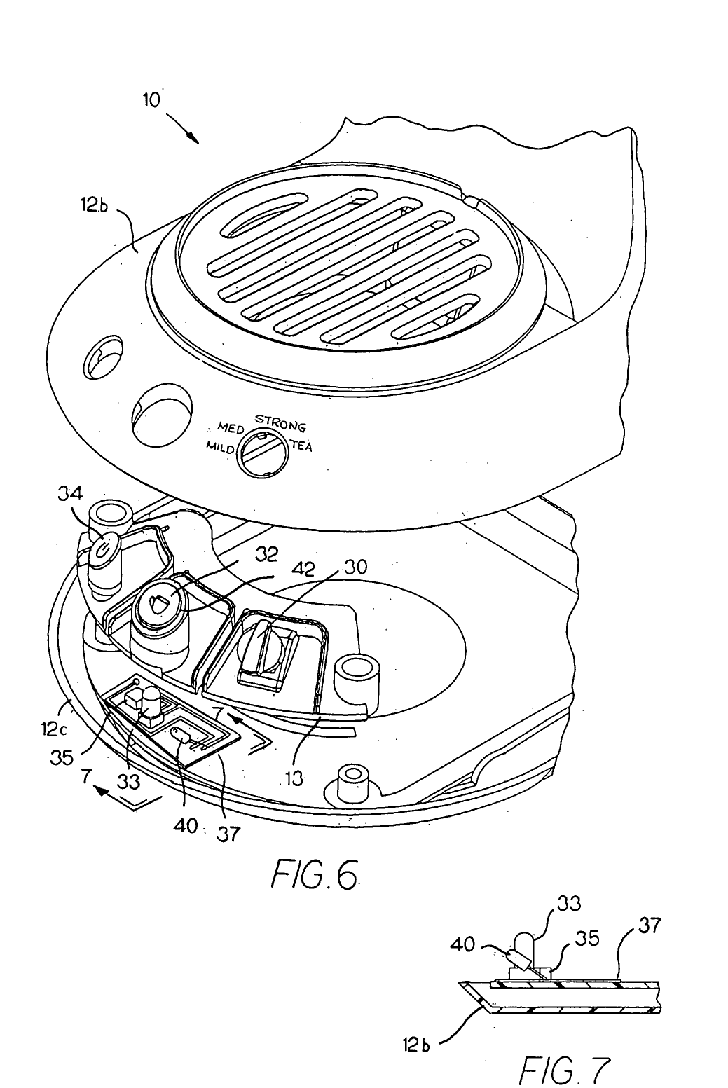

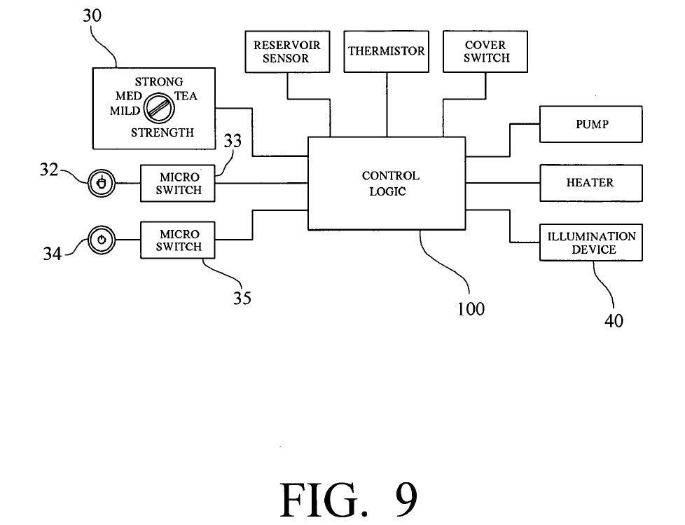

Referring now to FIG. 6, it can be seen that, in this exemplary embodiment, the selector switch 30 and buttons 32, 34 are mounted on a common tray 13 that is then interposed between first and second housing portions 12b, 12c during assembly of the brewer 10. Furthermore, as shown in FIG. 6, the power button 34 engages a microswitch 35 mounted below the button 34 on a circuit board 37 in the second housing portion 12c, such that depression of the button 34 closes the microswitch 35. The microswitch 35 is in electrical communication with a control logic 100 (as generally depicted in FIG. 9), which initiates certain actions in response to the closing of the microswitch 35, as is further described below. Indeed, this control logic 100 operates all components of the brewer 10, and it should be recognized and understood that the control logic 100 in this exemplary embodiment is a software code that is resident on the circuit board 37 within the brewer 10. Furthermore, the control logic 100 is described in additional detail below with reference to FIG. 9. Similarly, the brew button 32 engages a microswitch 33 mounted below the button 32 on the circuit board 37 in the second housing portion 12c, such that depression of the button 32 closes the microswitch 33. This microswitch 33 is also in electrical communication with the control logic 100, which initiates the brewing process in response to the closing of the microswitch 33.

Referring still to FIG. 6, there is also an illumination device 40 mounted on the circuit board 37 in the second housing portion 12c near the microswitches 33, 35. In this exemplary embodiment, this illumination device 40 is a high-intensity, tri-color light-emitting diode (LED), which can be programmed to emit red light, green light, blue light, or a combination thereof, as dictated by the control logic 100. This illumination device 40 is designed to provide visual indication of the operational status of the brewer 10.

Specifically, the brew button 32 is surrounded by a cylindrical element 42 that serves as a waveguide or light pipe, directing the light emitted from the illumination device 40 along its length such that the distal rim of the cylindrical element 42 that circumscribes the brew button 32 is illuminated. In this exemplary embodiment, the cylindrical element 42 is integral with the tray 13 and is in a substantially perpendicular orientation relative to the underlying circuit board 37. Furthermore, in this exemplary embodiment, the cylindrical element 42 is composed of a polycarbonate resin material distributed under the trademark LEXAN® by the General Electric Company of Pittsfield, Mass., although other materials could be used without departing from the spirit and scope of the present invention. Finally, and as illustrated in the sectional view of FIG. 7, it has been determined that by orienting the light-emitting diode at approximately 25° relative to the underlying circuit board 37, optimal light transmission to the cylindrical element 42 is achieved.

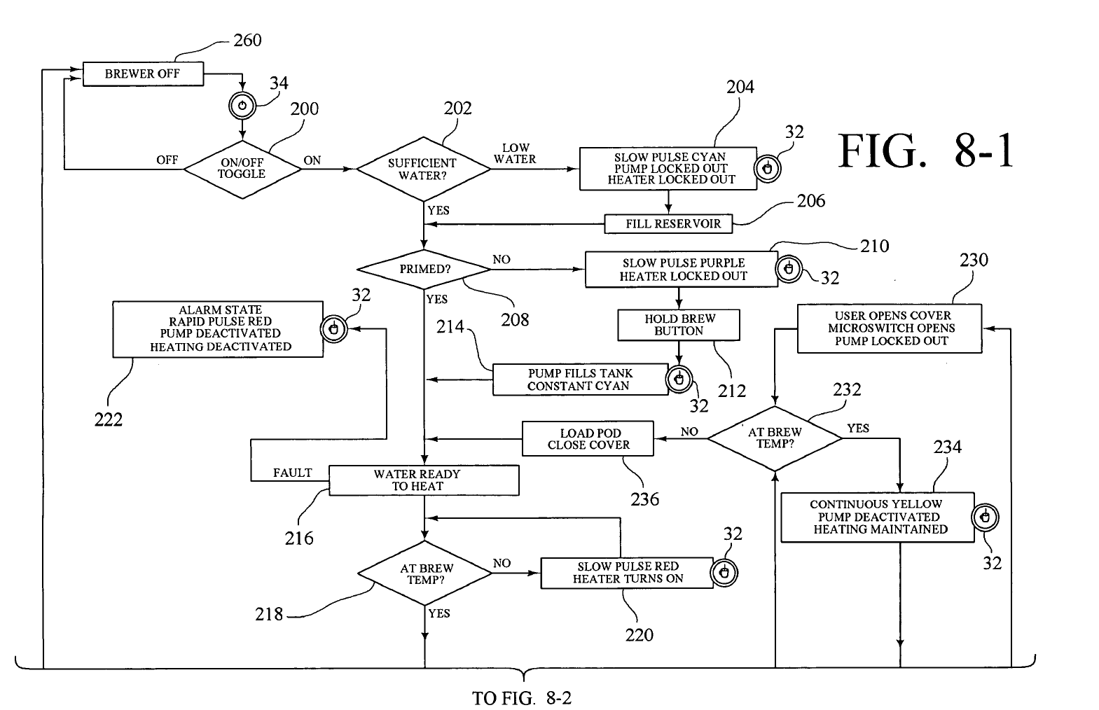

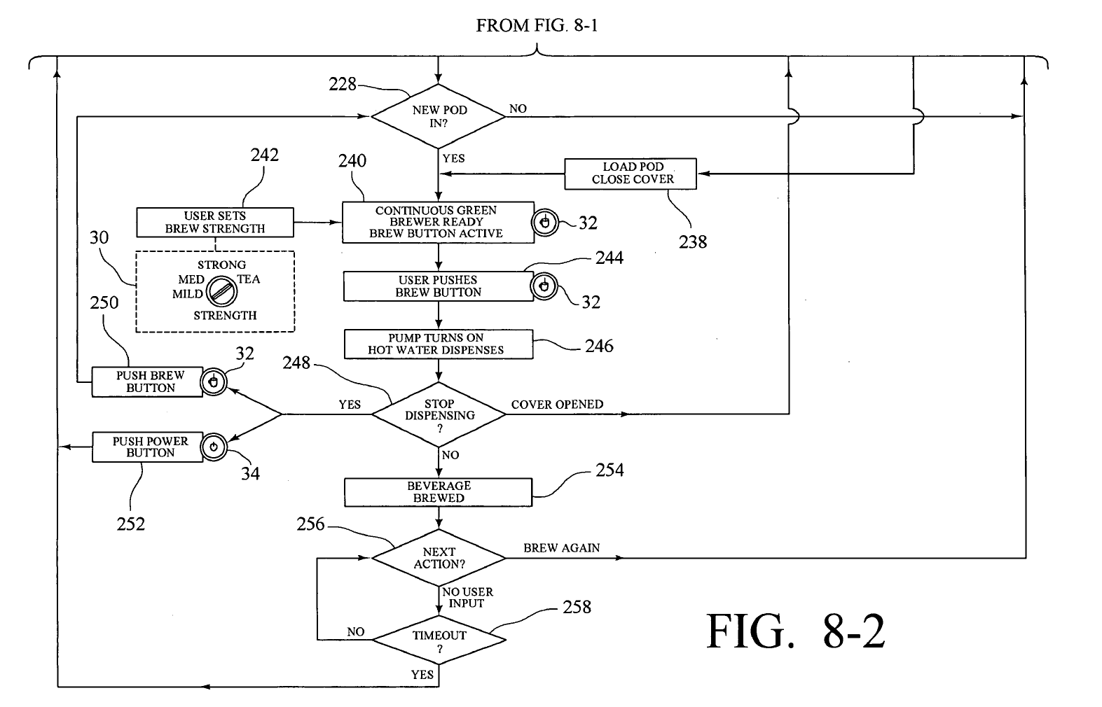

By illuminating the cylindrical element 42 in this manner, the operational status of the brewer 10 can be readily communicated to the user. In this regard, FIG. 8 is a workflow diagram, illustrating the operation of the exemplary brewer 10. Of particular relevance to the present invention are the various visual indicators that are generated to indicate certain conditions of the brewer 10.

For example, in this exemplary embodiment, when the exemplary brewer 10 is turned on by pressing the power button 34, as indicated by decision 200 in FIG. 8, a diagnostic sequence is initiated, and the control logic 100 preferably causes the illumination device 40 to cycle through red, blue, and green lights, which are then viewable by the user at the distal rim of the cylindrical element 42 that circumscribes the brew button 32. If the brewer 10 determines that there is insufficient water in the reservoir, as indicated by decision 202 in FIG. 8, the control logic 100 causes the illumination device 40 to generate a pulsing blue light, and the pump and water heater are locked out and prevented from operating, as indicated by block 204 in FIG. 8. In this regard, the determination of whether there is sufficient water in the reservoir may be accomplished by positioning a buoyant float containing a magnet within the reservoir, with a corresponding magnetic reed switch mounted outside of the reservoir on an internal surface of the housing 12. Of course, various other commercially available sensors and/or switches could also be used without departing from the spirit and scope of the present invention. In any event, the reservoir must then be re-filled by the user, as indicated at block 206.

If there is sufficient water in the reservoir, a determination is made as to whether the brewer 10 has been previously operated and primed, as indicated by decision 208 in FIG. 8. In this regard, the control logic 100 stores a “flag” indicating that the brewer 10 has not been previously operated, in which case, the control logic 100 causes the illumination device 40 to generate a pulsing purple light (i.e., a combination of red and blue lights), prompting the user to initiate an initial priming, as indicated by block 210 in FIG. 8. To initiate the initial priming, the user holds the brew button 32 for a set period of time (e.g., five seconds), as indicated by block 212 in FIG. 8, which causes the pump to operate for a time period sufficient to fill the hot water tank and dispense a small quantity of water through the brew head. While the hot water tank is being filled, the control logic 100 causes the illumination device 40 to generate a non-pulsing blue light, as indicated by block 214 in FIG. 8. Once the hot water tank is filled, the flag is null, and the control logic 100 thereafter assumes that there is water in the hot water tank.

Assuming there is sufficient water in the reservoir and initial priming has been completed, the water in the hot water tank is considered ready to heat, as indicated by block 216 in FIG. 8. Accordingly, a determination is made as to whether the water is at the predetermined brew temperature, as indicated by decision 218 in FIG. 8. If not, the heater is energized to heat the water in the hot water tank, and the control logic 100 causes the illumination device 40 to generate a slow pulsing red light, as indicated by block 220 in FIG. 8. During this heating cycle, should the water temperature exceed a predetermined limit, and indicate a fault condition, the control logic 100 causes the illumination device 40 to generate a rapid pulsing red light, and the pump and water heater are deactivated, as indicated by block 222 in FIG. 8. In this regard, the determination of whether the water temperature exceeds a predetermined limit may be accomplished by positioning a thermistor in the hot water tank for measuring and reporting water temperature to the control logic 100. Of course, various other commercially available sensors could also be used without departing from the spirit and scope of the present invention. In any event, an attempt to recover is then made, as indicated by block 224 of FIG. 8, and if unsuccessful, the brewer 10 must be repaired or replaced, as indicated by block 226 in FIG. 8.

Once the water in the hot water tank reaches the predetermined brew temperature, there is preferably a determination as to whether a new pod 60 has been positioned below the brew head, as indicated by decision 228 in FIG. 8. This may be accomplished by a mechanically actuated switch for sensing whether the cover 14 is open. If the cover 14 is opened and then closed, the control logic 100 presumes that replacement of the pod 60 has taken place. If a new pod 60 has not been positioned below the brew head, the user must open the cover 14 to access the drawer 12a that retains the pod 60 in the pod holder 16 below the brew head, which signals the control logic 100 to lock out the pump, as indicated by block 230 in FIG. 8. If the water in the hot water tank is not at the predetermined brew temperature, as indicated by decision 232 in FIG. 8, once a pod 60 is loaded and the cover 14 closed by the user, as indicated by block 236 in FIG. 8, the water in the hot water tank is considered ready to heat, as indicated by block 216 in FIG. 8. On the other hand, if the water in the hot water tank is already at the predetermined brew temperature, the control logic 100 causes the illumination device 40 to generate a non-pulsing yellow light (i.e., a combination of red and green lights), and the pump is deactivated while heating is maintained, as indicated by block 234 in FIG. 8. Once a pod 60 is loaded and the cover 14 closed by the user, as indicated by block 238 in FIG. 8, the brewing process continues.

When the water in the hot water tank at the predetermined brew temperature and the pod 60 received and positioned below the brew head, the brewer 10 is ready to commence with the actual brewing and dispensing of the beverage, and the control logic 100 causes the illumination device 40 to generate a non-pulsing green light, as indicated by block 240 in FIG. 8. Then, by making an appropriate selection using the selector switch 30 (as indicated by block 242 in FIG. 8), and pressing the brew button 32 (as indicated by block 244 in FIG. 8), the brewing and dispensing process commences with hot water being delivered to the brew head and distributed over the pod 60 (as indicated by block 246 in FIG. 8).

Referring still to FIG. 8, the dispensing of the beverage can be interrupted and stopped by various actions, as indicated by decision 248 in FIG. 8. Specifically, should the user push the brew button 32 (as indicated by block 250 in FIG. 8), push the power button 34 (as indicated by block 252 in FIG. 8), or open the cover 14, the dispensing of the beverage is interrupted and stopped. If there is no such interruption, dispensing continues until a predetermined volume of hot water is distributed to and passes over and through the coffee pod, with the brewed beverage being dispensed through an outlet and into a cup or similar receptacle, as indicated by block 254 in FIG. 8.

Once the brewing process has terminated, there is a period of time in which the user can indicate a further action is requested, i.e., brewing and dispensing a second beverage, indicated by decision 256 in FIG. 8. Specifically, the opening of the cover 14 by the user will signal that a second beverage is to be brewed. If not, after a predetermined time period in which no user action is taken, the brewer 10 shuts down and returns to a “sleep mode,” as indicated by decision 258 and block 260 in FIG. 8.

FIG. 9 is a block diagram that further illustrates the inputs received by and outputs controlled by the control logic 100. First, as should be clear from the above description, the control logic 100 received appropriate signals from the selector switch 30, brew button 32 (through the microswitch 33), and power button 34 (through the microswitch 35). Additionally, the control logic 100 receives signals from a sensor associated with the water level in the reservoir; a thermistor in the hot water tank; and a switch associated with the cover for determining whether the cover has been opened, each of which has been described above. With benefit of these inputs, the control logic 100 then operates the pump, water heater, and the illumination device 40.

Of course, the above are only examples of the particular visual indicators that could be used to indicate the operational status of the brewer 10, and a wide range of colors and pulsing patterns could be used without departing from the spirit and scope of the present invention.

One of ordinary skill in the art will also recognize that additional embodiments are possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become obvious to those skilled in the art upon reading this disclosure and may be made without departing from the spirit or scope of the claimed invention

What is claimed is:

1. A control center for a brewer, comprising:
a programmable illumination device; and
a control logic for operating the programmable illumination device so as to provide visual indication of an operational status of the brewer.

2. The control center for a brewer as recited in claim 1, and further comprising:
a brew button for initiating the brewing process, said programmable illumination device being positioned near said brew button.

3. The control center for a brewer as recited in claim 1, wherein said programmable illumination device is a light-emitting diode.

4. The control center for a brewer as recited in claim 1, wherein said programmable illumination device can be programmed to emit red light, green light, blue light, or a combination thereof as dictated by the control logic.

5. The control center for a brewer as recited in claim 3, and further comprising
a brew button for initiating the brewing process; and
a waveguide that directs light emitted from the light-emitting diode along its length to a visible surface of the brewer.

6. The control center for a brewer as recited in claim 5, wherein said waveguide is a cylindrical element that circumscribes the brew button.

7. The control center for a brewer as recited in claim 6, wherein said waveguide is in a substantially perpendicular orientation relative to an underlying circuit board.

8. The control center for a brewer as recited in claim 7, wherein said light-emitting diode is oriented at approximately 25° relative to the underlying circuit board.

9. The control center for a brewer as recited in claim 5, wherein said waveguide is mounted on a common tray with the brew button, said tray being interposed between first and second housing portions of the brewer.

10. The control center for a brewer as recited in claim 9, wherein a circuit board is positioned below said tray, with the light-emitting diode being mounted to the circuit board so as to emit light into the waveguide.

11. The control center for a brewer as recited in claim 10, wherein said waveguide is a cylindrical element that circumscribes the brew button.

12. The control center for a brewer as recited in claim 11, wherein said waveguide extends from upwardly from said tray in a substantially perpendicular orientation relative the circuit board.

13. The control center for a brewer as recited in claim 12, wherein said light-emitting diode is oriented at approximately 25° relative to the circuit board.

14. The control center for a brewer as recited in claim 1, wherein visual indication of the operational status of the brewer is based on a color and a pulsing pattern of the light emitted by the programmable illumination device

15. The control center for a brewer as recited in claim 1, wherein said brewer includes a reservoir and hot water tank, and wherein said operational status includes any one of the following conditions:
(a) insufficient water in the reservoir;
(b) filling of the hot water tank;
(c) water temperature in the hot water tank exceeds a predetermined limit;
(d) water in the hot water tank being heated to a predetermined brew temperature; and
(e) water in the hot water tank at the predetermined brew temperature.

16. A control center for a brewer, comprising:
a light-emitting diode;
a waveguide that directs light emitted from the light-emitting diode along its length to a visible surface of the brewer; and
a control logic for operating the light-emitting diode so as to provide visual indication of an operational status of the brewer.

17. The control center for a brewer as recited in claim 16, wherein said light-emitting diode can be programmed to emit red light, green light, blue light, or a combination thereof as dictated by the control logic.

18. The control center for a brewer as recited in claim 16, and further comprising a brew button for initiating the brewing process.

19. The control center for a brewer as recited in claim 18, wherein said waveguide is a cylindrical element that circumscribes the brew button.
